(19) United States
(12) Patent Application Publication
(10) Pub. No.: US 2021/0394518 A1
(43) Pub. Date: Dec. 23, 2021

(54) INKJET RECORDING APPARATUS, NOZZLE MAINTENANCE METHOD, AND COMPUTER READABLE STORAGE MEDIUM

(71) Applicant: Konica Minolta, Inc., Tokyo (JP)

(72) Inventor: Shigetaka KUROSU, Tokyo (JP)

(21) Appl. No.: 17/340,650

(22) Filed: Jun. 7, 2021

(30) Foreign Application Priority Data
Jun. 23, 2020 (JP) 2020-108080

(51) Int. Cl. B41J 2/165; B41J 2/185; B41J 2/175

(52) U.S. Cl. CPC B41J 2/16579; B41J 2/175; B41J 2/185

(57) ABSTRACT

An inkjet recording apparatus includes: an inkjet head that has nozzles that discharge ink; a pressure applicator that applies an external force to the ink; a hardware processor; and a flow detector. The hardware processor controls a maintenance mode in which the pressure applicator applies the external force to the ink and forces the ink to be discharged from the nozzles. The flow detector detects flow of the ink discharged from the nozzles by the pressure applicator during the maintenance mode. The hardware processor then determines an ink discharge status at the nozzles based on a detection result by the flow detector.

### CROSS-REFERENCE TO RELATED APPLICATIONS

The entire disclosure of Japanese Patent Application No. 2020-108080 filed on Jun. 23, 2020 is incorporated herein by reference in its entirety.

### BACKGROUND

### Technological Field

The present invention relates to an inkjet recording apparatus, a nozzle maintenance method, and a computer readable storage medium.

### Description of Related Art

There is known a conventional inkjet recording apparatus that includes an inkjet head that discharges ink from nozzles to forms an image, structure, and the like on a medium.

In a method of detecting a nozzle discharge failure in the inkjet head that has been known and used, for example, a pattern printed on a printing medium is read with an optical sensor such as a CCD (Charge Coupled Device).

In relation to the above, JPH6-155765A discloses a technique for detecting a nozzle discharge failure based on a difference between image data obtained by reading an inspection sheet with a CCD sensor and image data obtained by printing a test pattern on the inspection sheet and then reading the printed inspection sheet again.

However, in order to detect a nozzle discharge failure according to the technique in JPH6-155765A, unnecessary processes of printing a test pattern on the recording media and reading it with an optical sensor are required, a lot of sheets are wasted, and the like. In addition, a detection system requires high cost components.

In addition, even when a nozzle discharge failure can be detected, the cause of the failure is not clear. As a result, there is a problem of not being able to perform appropriate recovery operations, but of performing unnecessary head replacement, wasting a large amount of ink due to excessive maintenance, and the like.

### SUMMARY

An object of the present invention is to provide an inkjet recording apparatus, a nozzle maintenance method, and a computer readable storage medium storing a program that can automatically determine the ink discharge status at a nozzle with relative ease.

In order to achieve at least one of the abovementioned objects, according to a first aspect of the present disclosure, there is provided an inkjet recording apparatus including:

an inkjet head that has nozzles that discharge ink;

a pressure applicator that applies an external force to the ink;

a hardware processor that controls a maintenance mode in which the pressure applicator applies the external force to the ink and forces the ink to be discharged from the nozzles; and

a flow detector that detects flow of the ink discharged from the nozzles by the pressure applicator during the maintenance mode, wherein

the hardware processor determines an ink discharge status at the nozzles based on a detection result by the flow detector.

In order to achieve at least one of the abovementioned objects, according to a second aspect of the present disclosure, there is provided a nozzle maintenance method performed in an inkjet recording apparatus including an inkjet head that has nozzles that discharge ink, the method including:

applying an external force to the ink;

controlling a maintenance mode in which an external force is applied to the ink and the ink is forced to be discharged from the nozzles;

detecting, during the maintenance mode, flow of the ink discharged from the nozzles in the applying; and

determining an ink discharge status at the nozzles based on a detection result in the detecting.

In order to achieve at least one of the abovementioned objects, according to a third aspect of the present disclosure, there is provided a non-transitory computer readable storage medium storing a program that causes a computer of an inkjet recording apparatus to function as a hardware processor,
the inkjet recording apparatus including:
   an inkjet head that has nozzles that discharge ink;
   a pressure applicator that applies an external force to the ink; and
   a flow detector that detects flow of the ink discharged from the nozzles by the pressure applicator during a maintenance mode in which an external force is applied to the ink and the ink is forced to be discharged from the nozzles,

the hardware processor determining an ink discharge status at the nozzles based on a detection result by the flow detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 shows a configuration of an inkjet recording apparatus of an embodiment of the present invention;

FIG. 2 shows a configuration in the vicinity of a pressure applicator and a flow detector of the embodiment of the present invention;

FIG. 3 is a block diagram regarding control by a controller of the embodiment of the present invention;

FIG. 4 is a flowchart of a sequence of ink flow detection operations;

FIG. 5A shows a change in ink flow over time when ink is normally discharged from a nozzle according to the embodiment of the present invention;

FIG. 5B shows a change in ink flow over time when the nozzle are unclogged according to the embodiment of the present invention;

FIG. 5C shows a change in ink flow over time when the nozzle are not unclogged according to the embodiment of the present invention;

FIG. 5D shows a change in ink flow over time when the nozzle include an air bubble according to the embodiment of the present invention;

FIG. 6 is flowchart showing a maintenance mode according to the embodiment of the present invention; and

FIG. 7 shows a configuration in the vicinity of a pressure applicator and a flow detector of a modified example of the present invention.

### DETAILED DESCRIPTION OF THE EMBODIMENTS

Hereinafter, one or more embodiments of the present invention will be described with reference to the drawings. However, the scope of the invention is not limited to the disclosed embodiments.

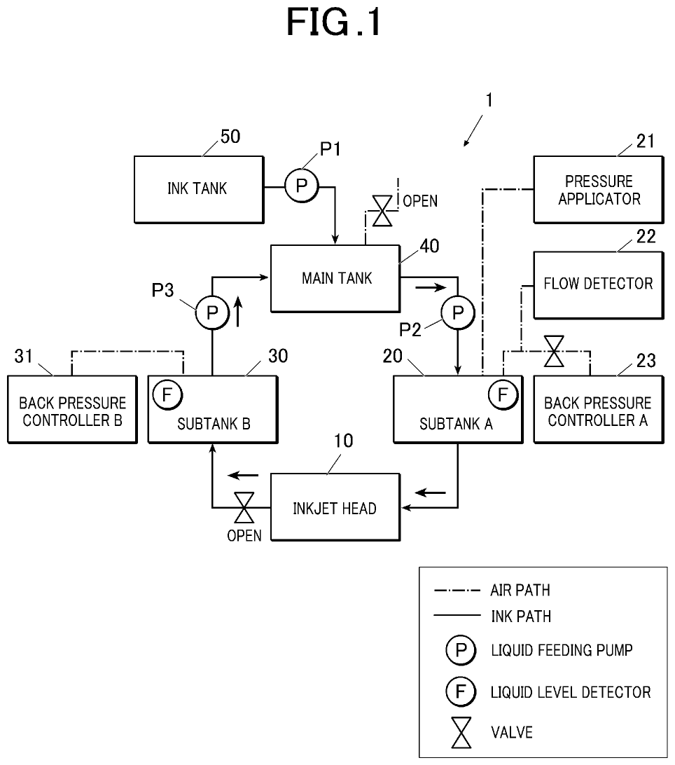

FIG. 1 shows a configuration of an inkjet recording apparatus 1.

The inkjet recording apparatus 1 includes an inkjet head 10, a subtank A 20, a subtank B 30, a main tank 40, and an ink tank 50.

The subtank A 20 is a metal rigid sealed tank with ink and air inside, and includes an ink amount detection sensor, which is a liquid level detector, inside.

The subtank A 20 is also connected to a pressure applicator 21, and a flow detector 22 via an air path, and a back pressure controller A 23 via an air path and a valve.

The back pressure controller A 23 controls air pressure in the subtank A 20 and adjusts the pressure applied to the ink in the subtank A 20.

The subtank B 30 includes ink and air inside, and includes an ink amount detection sensor, which is a liquid level detector, inside.

The subtank B 30 is connected to a back pressure controller B 31 via an air path.

The back pressure controller B 31 controls pressure in the subtank B 30 and adjusts the pressure applied to the ink in the subtank B 30.

The main tank 40 is connected to the outside air via a valve, which is open.

Ink is fed from the ink tank 50 to the main tank 40 by a liquid feeding pump P1, and fed from the main tank 40 to the subtank A 20 by a liquid feeding pump P2, according to the consumption amount detected by the ink amount detection sensor in the subtank A 20. By controlling the back pressure difference between the subtank A 20 and the subtank B 30, ink is fed from subtank A 20 to the inkjet head 10. Ink that is not consumed in image formation in the inkjet head 10 is collected in the subtank B 30 through an open valve. When the ink amount detection sensor in the subtank B 30 detects that the ink has reached the capacity limit, the liquid feeding pump P3 returns the ink to the main tank 40.

As described above, ink circulates through the main tank 40, the subtank A 20, the inkjet head 10, the subtank B 30, and the main tank 40 in this order. The arrows shown in FIG. 1 represent the directions of ink flow.

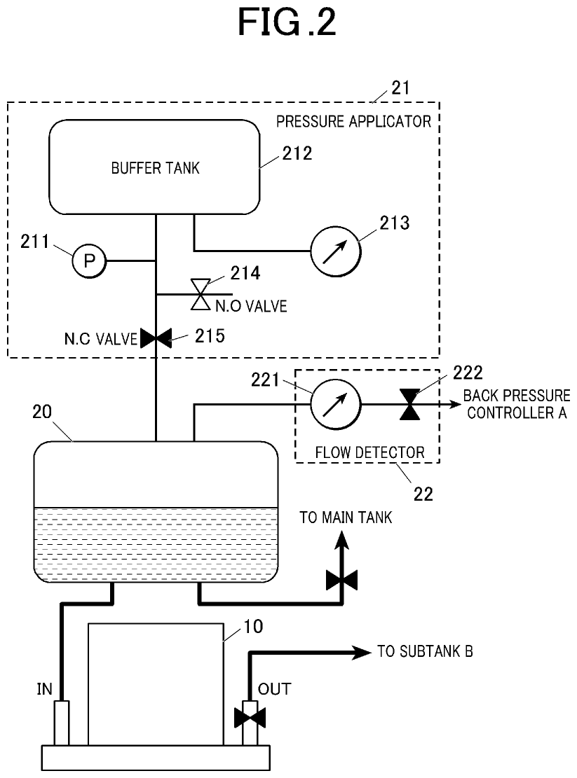

FIG. 2 shows a configuration in the vicinity of the pressure applicator 21 and the flow detector 22. The pressure applicator 21 includes a pressure pump 211, a buffer tank 212, a pressure gauge 213, an N.O valve 214, and an N.C valve 215.

The pressure pump 211 pressurizes the air.

The buffer tank 212 stores the air pressurized by the pressure pump 211.

The pressure gauge 213 measures the air pressure in the buffer tank 212.

The N.O valve 214 is closed when the pressurization in the subtank A 20 is started and is used to release the air to the atmospheric pressure after a predetermined period.

The N.C valve 215 is opened when pressurized air is passed into the subtank A 20.

The flow detector 22 includes a pressure gauge 221 that measures the pressure in the subtank A 20 and a valve 222 that connects the pressure gauge 221 to the back pressure controller A 23.

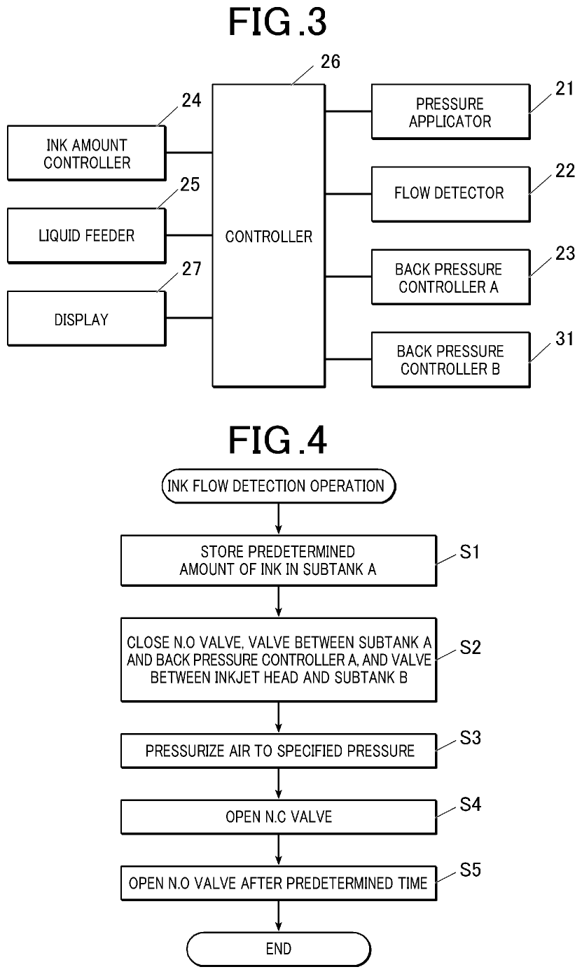

The inkjet recording apparatus 1 includes a controller 26 (hardware processor) shown in FIG. 3. FIG. 3 is a block diagram regarding control by the controller 26.

The controller 26 is composed of a CPU (Central Processing Unit) and the like, and controls the pressure applicator 21, the flow detector 22, the back pressure controller A 23, the back pressure controller B 31, an ink amount controller 24, a liquid feeder 25, and a display 27.

The controller 26 controls the ink amount controller 24 and the liquid feeder 25 to feed ink from the main tank 40 to the subtank A 20 according to the ink consumption detected by the ink amount detection sensor in the subtank A 20. Also, the controller 26 uses the ink amount controller 24 and the liquid feeder 25 to return ink from the subtank B 30 to the main tank 40 when the ink amount detection sensor in the subtank B 30 detects that the ink has reached the limit of the capacity of subtank B 30.

The display 27 displays operation screens and the like according to instructions from the controller 26. An LCD (Liquid Crystal Display), an OELD (Organic Electro Luminescence Display), or the like can be used as the display 27.

The controller 26 performs a sequence of ink flow detection operations shown in FIG. 4 during a maintenance mode described later. In addition, during execution of the sequence of operations, the controller 26 controls the flow detector 22 to record the change in ink flow over time, which is the change over time in the pressure in the subtank A 20. Therefore, it is possible to immediately apply and release an external force to and from the ink in the vicinity of a nozzle(s), and to detect the ink flow at that time.

Furthermore, the controller 26 determines an ink discharge status at the nozzle of the inkjet head 10 based on the change over time of the ink flow during the sequence of operations. Here, the controller 26 functions as a determination unit.

First, the controller 26 controls the ink amount controller 24 and the liquid feeder 25 to store ink such that the ink amount detection sensor detects a predetermined amount of ink in the subtank A 20 (Step S1).

Next, the controller 26 closes the N.O valve 214, the valve between the subtank A 20 and the back pressure controller A 23, and the valve between the inkjet head 10 and the subtank B 30 (Step S2).

Next, the controller 26 controls the pressure pump 211 to pressurize the air in the buffer tank 212 to a specified pressure (Step S3).

Next, the controller 26 opens the N.C valve 215 (Step S4). By passing the pressurized air into the subtank A 20, the ink in the subtank A 20 is pressurized, and external pressure is immediately applied to the ink in the vicinity of the nozzle of the inkjet head 10. When no nozzle is clogged, the ink is immediately ejected from the nozzle by the applied external pressure.

Next, the controller 26 opens the N.O valve 214 after a predetermined time from the opening of the N.C valve 215 (Step S5). By opening the N.O valve 214, the pressure in the buffer tank 212 and the pressure in the subtank A 20 are released to the atmospheric pressure, and the sequence of operations is finished.

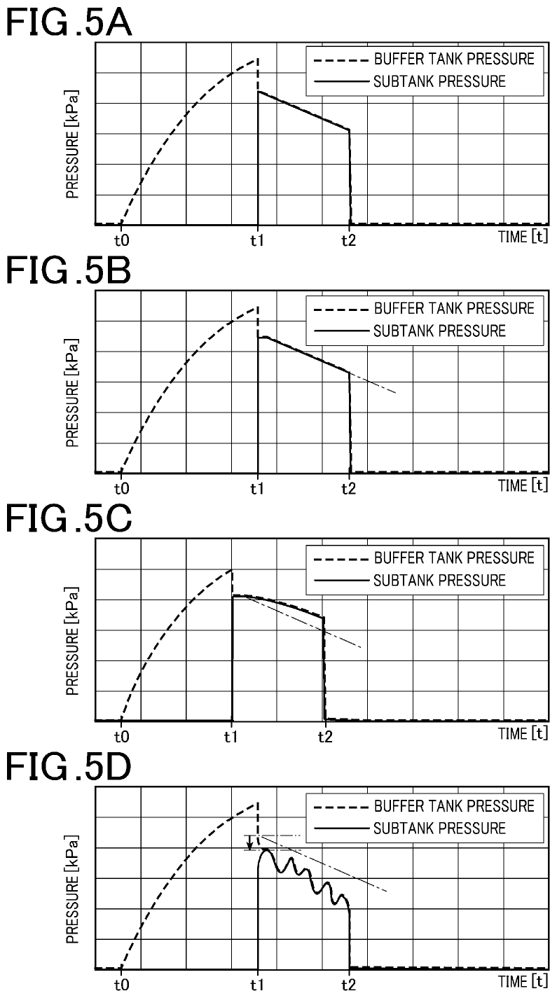

FIG. 5A to FIG. 5D show the pressure in the buffer tank 212 detected by the pressure gauge 213 and change in ink flow over time in the subtank A 20 detected by the flow detector 22 when the sequence of ink flow detection operations shown in FIG. 4 is performed.

In FIG. 5A to FIG. 5D, time “t0” is when the air in the buffer tank 212 is started to be pressurized using the pressure pump 211. Time “t1” is when the N.C valve 215 is opened as the pressure of the air in the buffer tank 212 reaches the specified pressure. Time “t2” is when the N.C valve 214 is opened after the predetermined time has elapsed from the opening of the N.C valve 215.

The specified pressure and the time between t1 and t2 can be set as appropriate.

FIG. 5A shows the change in ink flow over time in the subtank A 20 (solid line) and the change in pressure over time in the buffer tank 212 (dashed line) when the nozzle is not clogged, that is, when the ink discharge status at the nozzle is normal.

When the nozzle is not clogged, the ink immediately begins to be ejected from the nozzle in response to the pressure applied to the ink at the time t1. As the ink is ejected, the pressure in the subtank A 20 decreases almost linearly until the time t2 (that is, the pressure decays at a constant rate).

After the time t1, the pressure in the buffer tank 212 is the same as the pressure in the subtank A 20.

FIG. 5B shows the change in ink flow over time in the subtank A 20 and the change in pressure over time in the buffer tank 212 when the nozzle has been clogged but is unclogged in the middle of applying pressure to the ink.

When there is a discharge failure due to the clogged nozzle, pressure in the subtank A 20 does not decrease immediately after the time t1 in spite of the pressure applied to the ink, as the ink is not immediately ejected from the nozzle. FIG. 5B shows a state where the pressure in the subtank A 20 does not change temporarily immediately after the time t1 in spite of the pressure applied to the ink.

In FIG. 5B, after the temporary state of no change in pressure, the pressure in the subtank A 20 changes (decays) similar to the pressure in a normal case. This means that a minor nozzle clogging has occurred, but the nozzle is already unclogged during the process of applying pressure to the ink. The single-dotted line shows the pressure decaying change in a normal case.

After the time t1, the pressure in the buffer tank 212 is the same as the pressure in the subtank A 20.

FIG. 5C shows the change in ink flow over time in the subtank A 20 and the change in pressure over time in the buffer tank 212 when the nozzle has been clogged and is not unclogged even after application of pressure to the ink. FIG. 5C shows a state where the pressure in the subtank A 20 does not change temporarily immediately after the time t1 in spite of the pressure applied to the ink.

After the state where the pressure does not change, the pressure in the subtank A 20 starts to decay, but the rate of decay (change) is smaller than that in a normal case. This indicates that the clogged nozzle is not unclogged. The single-dotted line shows the decay (change) of the pressure in a normal case.

After the time t1, the pressure in the buffer tank 212 is the same as the pressure in the subtank A 20.

FIG. 5D shows the change in ink flow over time in the subtank A 20 and the change in pressure over time in the buffer tank 212 when there is an air bubble(s) in the nozzle.

When there is a discharge failure due to a large air bubble in the nozzle, the ratio of a volume of the air to a total volume from the buffer tank 212 to the inkjet head 10 is large. As a result, the pressure waveform immediately after the time t1 may be distorted or become lower than the pressure in a normal case. The arrow shown in FIG. 5D indicates that the pressure is lower than the pressure in a normal case.

The waveform of the change in the pressure over time between the time t1 and t2 is disturbed because of the air bubble ejected from the nozzle with ink. The single-dotted line shows the pressure decaying change in a normal case.

After the time t1, the pressure in the buffer tank 212 is the same as the pressure in the subtank A 20.

The controller 26 performs the maintenance mode when the inkjet recording apparatus 1 is turned on, or at a timing based on a cycle that is appropriately set according to temperature or humidity of the outside air, printing rate, or time during which the apparatus is left unused.

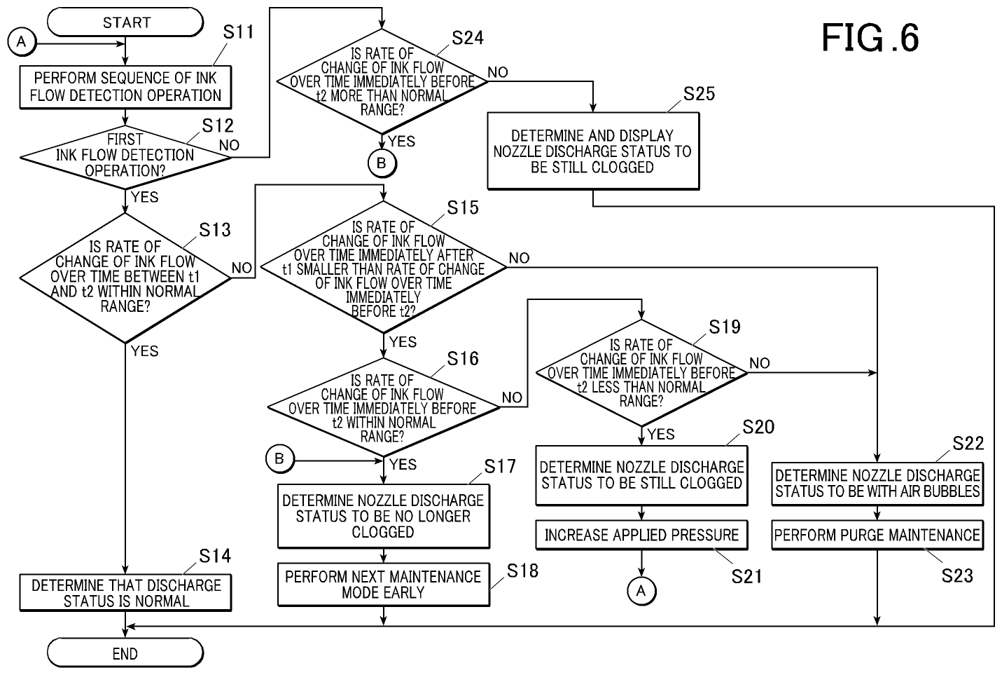

FIG. 6 shows a flowchart of the maintenance mode.

The “t1” and “t2” in FIG. 6 are the same as those in FIG. 5A to FIG. 5D. That is, the time “t1” is when the N.C valve 215 is opened as the pressure of the air in the buffer tank 212 reaches the specified pressure during the sequence of ink flow detection operations. The time “t2” is when the N.C valve 214 is opened after the predetermined time has elapsed from the opening of the N.C valve 215 during the sequence of ink flow detection operations.

First, the controller 26 performs the sequence of ink flow detection operations shown in FIG. 4 (Step S11).

Next, the controller 26 determines whether or not the sequence of ink flow detection operations performed in Step S11 is performed for the first time (Step S12).

If the sequence of ink flow detection operations is performed for the first time (Step S12; YES), the controller 26 determines whether or not the rate of change in the ink flow over time between the time t1 and the time t2 is within a normal range (Step S13).

If the rate of change in ink flow over time between the time t1 and the time t2 is within a normal range (Step S13; YES), the controller 26 determines that the discharge status at the nozzle is normal (Step S14), and finishes the maintenance mode.

If the rate of change in ink flow over time between the time t1 and the time t2 is not within a normal range (Step S13; NO), the controller 26 determines whether or not the rate of change in ink flow over time immediately before the time t1 is less than the rate of change in ink flow over time immediately before the time t2 (Step S15).

If the rate of change in ink flow over time immediately before the time t1 is less than the rate of change in ink flow over time immediately before the time t2 (Step S15; YES), the controller 26 determines whether or not the rate of change in ink flow over time immediately before the time t2 is within a normal range (Step S16).

If the rate of change in ink flow over time immediately before the time t2 is within a normal range (Step S16; YES), the controller 26 determines the discharge status that the nozzle has been clogged but is no longer clogged as a result of the sequence of ink flow detection operations (Step S17).

Next, the controller 26 sets the next maintenance mode to be performed earlier than the time set based on the cycle of performing the maintenance mode in order to ensure that the next maintenance mode is performed before the nozzle is clogged (Step S18), and finishes the maintenance mode.

If the rate of change in ink flow over time immediately before the time t2 is not within a normal range (Step S16; NO), the controller 26 determines whether or not the rate of change in ink flow over time immediately before the time t2 is less than the normal range (Step S19).

If the rate of change in ink flow over time immediately before the time t2 is less than the normal range (Step S19; YES), the controller 26 determines the discharge status that the nozzle has been clogged and is not unclogged even after the sequence of ink flow detection operations (Step S20).

Next, the controller 26 controls the pressure applicator 21 to apply a higher pressure to the ink than in the first sequence of ink flow detection operations (Step S21) in order to unclog the nozzle, and then performs the sequence of ink flow detection operations again. In other words, the controller 26 returns to the process of Step S11.

Next, since it is the second time to perform the sequence of ink flow detection operations, the controller 26 determines that the sequence of ink flow detection operations is not performed for the first time (Step S12; NO).

Next, the controller 26 determines whether or not the rate of change in ink flow over time immediately before the time t2 is within a normal range (Step S24) in the second sequence of ink flow detection operations (Step S24).

If the rate of change in ink flow over time immediately before the time t2 is within a normal range (Step S24; YES), the controller 26 proceeds to Step S17.

If the rate of change in ink flow over time immediately before the time t2 is not within a normal range (Step S24; NO), the controller 26 determines the discharge status that the nozzle has been clogged and is not unclogged even after the two sequences of ink flow detection operations, and displays the determination result on the display 27 (Step S25), and finishes the maintenance mode.

If the rate of change in ink flow over time immediately before the time t1 is not less than the rate of change in ink flow over time immediately before the time t2 (Step S15; NO), and if the rate of change in ink flow over time immediately before the time t2 is not less than a normal range (Step S19; NO), the controller 26 determines the discharge status that the nozzle includes an air bubble(s) (Step S22).

Next, the controller 26 performs purge maintenance (Step S23) to eject the air bubble in the nozzle, and finishes the maintenance mode. In the purge maintenance, the controller 26 controls the pressure applicator 21 to apply a higher pressure to the ink than in the sequence of ink flow detection operations in order to eject ink from the nozzle for a long time.

The controller 26 also controls the flow detector 22 to record the change in pressure over time in the subtank A 20 during the maintenance mode in FIG. 6.

As described above, the inkjet recording apparatus 1 according to the present embodiment includes an inkjet head 10 that has nozzles that discharge ink, a pressure applicator 21 that applies external force to the ink, a controller 26 (hardware processor) that controls a maintenance mode in which the pressure applicator 21 applies the external force to the ink and forces the ink to be discharged from the nozzles, a flow detector 22 that detects flow of the ink discharged from the nozzles by the pressure applicator 21 during the maintenance mode, and a determination unit (the controller 26) that determines an ink discharge status at the nozzles based on a detection result by the flow detector 22.

Accordingly, it is possible to provide an inkjet recording apparatus, a nozzle maintenance method, and a program that makes it possible to automatically determine the ink discharge status at the nozzle relatively easily.

### Modified Example

A modified example will be described in the followings mainly regarding the differences from the inkjet recording apparatus 1 of the above embodiment.

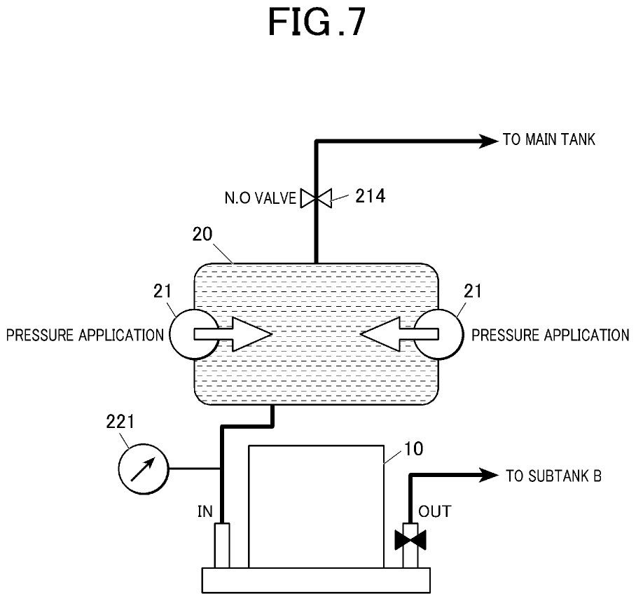

FIG. 7 shows a configuration in the vicinity of the pressure applicator 21 and the flow detector 22 in the modified example.

In the modified example, the subtank A 20 is made of a plastic material, and an ink path is connected from the subtank A 20 to the main tank 40 via the N.O valve 214.

In a sequence of ink flow detection operations according to the modified example, when the subtank A 20 is instantaneously pressurized by a pressurizing material(s), which is the pressure applicator 21, the ink in the subtank A 20 is subjected to an external force and then discharged from the nozzle of the inkjet head 10.

At this time, the pressure gauge 221, which is the flow detector 22, records the change in ink flow over time. A flowmeter may be used instead of the pressure gauge 221.

The other components, steps in the sequence of ink flow detection operations, and the maintenance mode are the same as those of the inkjet recording apparatus 1 of the above embodiment.

Also according to the above configurations of the modified example of the present embodiment, it is possible to provide an inkjet recording apparatus, a nozzle maintenance method, and a program that can automatically determine the state of ink discharge at a nozzle with relative ease.

The present invention is not limited to the above embodiment, and may be modified in various ways.

For example, in the inkjet recording apparatus 1 according to the above embodiment and the modified example, the ink circulates through a flow path. However, the ink may not circulate in the inkjet recording apparatus 1.

Furthermore, in the inkjet recording apparatus 1 according to the above embodiment and the modified example, the pressure applicator 21 and the flow detector 22 are not limited to those described above, as long as it is possible to immediately apply and release an external force to and from the ink near the nozzle, and to detect the ink flow at that time.

The flow detector 22 may measure the flow rate (amount) of ink instead of the pressure.

In the inkjet recording apparatus 1 of the above embodiment, the pressure gauge 213 of the pressure applicator 21 may be omitted. In this case, the pressure of the air in the buffer tank 212 can be adjusted by the operating time of the pressure pump 211.

Furthermore, in Step S25 of the sequence of ink flow detection operations by the inkjet recording apparatus 1 according to the above embodiment and the modified example, the controller 26 displays, on the display 27, the ink discharge status at the nozzle that the nozzle is clogged (is not unclogged yet). However, the controller 26 may also display, on the display 27, the determination result(s) in Step(s) S14, S17, and/or S22 of the sequence of ink flow detection operations.

Although embodiments of the present invention have been described and illustrated in detail, the disclosed embodiments are made for purposes of illustration and example only and not limitation. The scope of the present invention should be interpreted by terms of the appended claims

What is claimed is:

1. An inkjet recording apparatus comprising:
an inkjet head that has nozzles that discharge ink;
a pressure applicator that applies an external force to the ink;
a hardware processor that controls a maintenance mode in which the pressure applicator applies the external force to the ink and forces the ink to be discharged from the nozzles; and
a flow detector that detects flow of the ink discharged from the nozzles by the pressure applicator during the maintenance mode, wherein
the hardware processor determines an ink discharge status at the nozzles based on a detection result by the flow detector.

2. The inkjet recording apparatus according to claim 1, wherein, in response to a determination result by the hardware processor, the hardware processor finishes, changes, or repeats the maintenance mode.

3. The inkjet recording apparatus according to claim 1, wherein, the flow detector detects change inflow over time after the pressure applicator applies the external force to the ink.

4. The inkjet recording apparatus according to claim 3, wherein, upon the change in flow over time from start of discharge of the ink from the nozzles to finish of the discharge being at a rate within a normal range that is set in advance, the hardware processor determines that the ink discharge status at the nozzles is normal and finishes the maintenance mode.

5. The inkjet recording apparatus according to claim 3, wherein, upon the change in flow over time at start of discharge of the ink from the nozzles being at a rate smaller than a normal rate that is set in advance, and upon the change in the flow over time immediately before finish of the discharge of the ink being at a rate within a normal range that is set in advance, the hardware processor determines that the nozzles that has been clogged are unclogged because of the discharge of the ink and finishes the maintenance mode.

6. The inkjet recording apparatus according to claim 5, wherein the hardware processor changes a timing at which the maintenance mode is performed next time to be a timing earlier than a timing that has been set.

7. The inkjet recording apparatus according to claim 3, wherein, upon the change in flow over time at start of discharge of the ink from the nozzles being at a rate smaller than a normal rate that is set in advance, and upon the change in flow over time immediately before finish of the discharge of the ink being at a rate smaller than a normal range that is set in advance, the hardware processor determines that the nozzles that has been clogged are not unclogged.

8. The inkjet recording apparatus according to claim 7, wherein the hardware processor enlarges the external force applied by the pressure applicator and performs the maintenance mode again.

9. The inkjet recording apparatus according to claim 3, wherein the hardware processor determines that the nozzles include an air bubble and performs a purge maintenance mode in which a larger amount of ink is discharged than in the maintenance mode, upon the change in flow over time satisfying none of following (a) to (c):
(a) upon the change in flow over time from start of discharge of the ink from the nozzles to finish of the discharge being at a rate within a normal range that is set in advance;
(b) upon the change in flow over time at start of discharge of the ink from the nozzles being at a rate smaller than a normal rate that is set in advance, and upon the change in the flow over time immediately before finish of the discharge of the ink being at a rate within a normal range that is set in advance; and
(c) upon the change in flow over time at start of discharge of the ink from the nozzles being at a rate smaller than a normal rate that is set in advance, and upon the change in flow over time immediately before finish of the discharge of the ink being at a rate smaller than a normal range that is set in advance.

10. The inkjet recording apparatus according to claim 1, further comprising a display that displays a determination result by the hardware processor.

11. A nozzle maintenance method performed in an inkjet recording apparatus including an inkjet head that has nozzles that discharge ink, the method comprising:
applying an external force to the ink;
controlling a maintenance mode in which an external force is applied to the ink and the ink is forced to be discharged from the nozzles;
detecting, during the maintenance mode, flow of the ink discharged from the nozzles in the applying; and
determining an ink discharge status at the nozzles based on a detection result in the detecting.

12. A non-transitory computer readable storage medium storing a program that causes a computer of an inkjet recording apparatus to function as a hardware processor,
the inkjet recording apparatus including:
an inkjet head that has nozzles that discharge ink;
a pressure applicator that applies an external force to the ink; and
a flow detector that detects flow of the ink discharged from the nozzles by the pressure applicator during a maintenance mode in which an external force is applied to the ink and the ink is forced to be discharged from the nozzles,
the hardware processor determining an ink discharge status at the nozzles based on a detection result by the flow detector.
